(19) United States
(12) Patent Application Publication
(10) Pub. No.: US 2013/0000197 A1
(43) Pub. Date: Jan. 3, 2013

(54) RAISED BED GARDENING APPARATUS

(76) Inventors: ANDREW VRANA, Houston, TX (US); Joseph Meppelink, Houston, TX (US)

(21) Appl. No.: 13/174,346

(22) Filed: Jun. 30, 2011

(51) Int. Cl. A01G 9/02

(52) U.S. Cl. 47/66.5; 47/79

(57) ABSTRACT

In one embodiment, a planter includes a plurality of sidewalls extending from a base, wherein the base in corrugated and includes alternating peaks and valleys thereon. An irrigation aperture disposed on at least one of the plurality of the sidewalls, wherein the irrigation aperture is adapted to receive a soak hose.

### BACKGROUND

The present disclosure relates generally to raised bed gardening planters for growing plants for vegetable and flower gardens. Specifically, the present disclosure relates to an inexpensive, movable, reusable planter including an integrated irrigation system that can be used in urban environments.

Gardening is a rather popular pastime enjoyed by numerous people. However, people in urban environments are sometimes unable to enjoy gardening due to lack of adequate planting space in urban environments. Therefore, a need exists for a planter system that is easily adapted for use in urban environments to grow fresh vegetables and/or flowers.

### SUMMARY OF THE INVENTION

In one embodiment, a planter includes a plurality of sidewalls extending from a base, wherein the base in corrugated and includes alternating peaks and valleys thereon. An irrigation aperture is disposed on at least one of the plurality of the sidewalls, wherein the irrigation aperture is adapted to receive a soak hose.

In another embodiment, a gardening system includes plurality of planters disposed adjacent one another, wherein each planter includes a plurality of sidewalls extending from a base. The base is corrugated and includes alternating peaks and valleys thereon. An irrigation aperture is disposed on at least one of the plurality of the sidewalls, wherein the irrigation aperture is adapted to receive a soak hose.

### BRIEF DESCRIPTION OF THE DRAWINGS

FIG. 1 illustrates an isometric view of a planter of the present disclosure;

FIG. 2 illustrates a plan view of the planter of FIG. 1;

FIG. 3 depicts a side elevation of the planter of FIG. 2;

FIG. 4 illustrates another embodiment of the planter of FIG. 1;

FIG. 5 illustrates yet another embodiment of the planter of FIG. 1; and

FIG. 6 shows a plurality of the planters of FIG. 1 in use in a garden.

### DESCRIPTION OF THE EMBODIMENTS

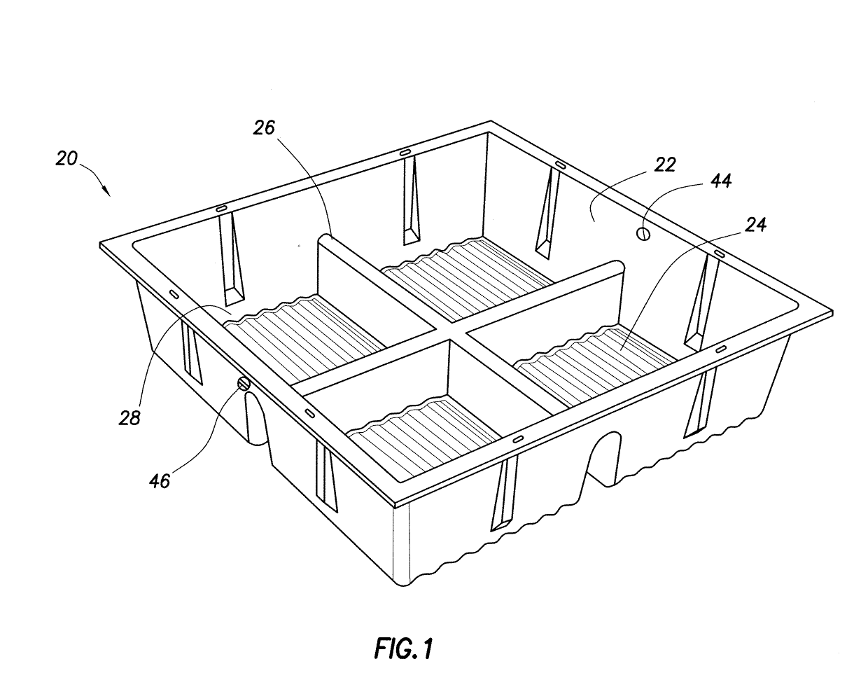

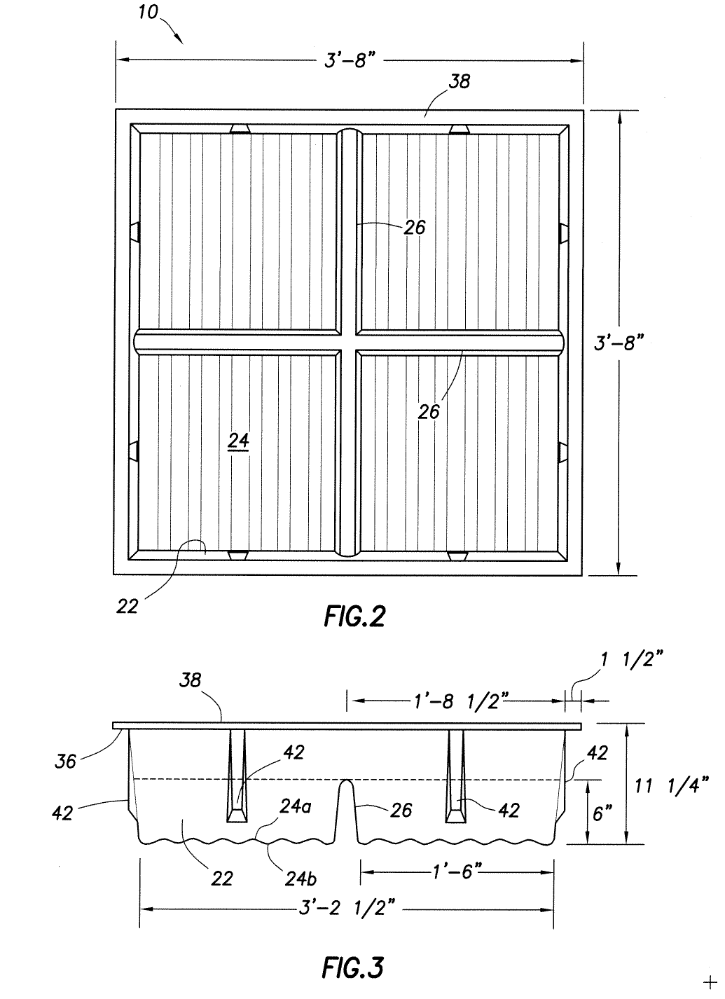

Turning now to FIG. 1, one embodiment of planter 20 is primarily made of a thin layer of high density polyethylene (HDPE) which is also known as plastic number 2. Other embodiments may be made of any suitable material such as fiberglass and/or other types of plastic as would be recognized by those of ordinary skill in the art. The use of HDPE provides advantages including but not limited to structural rigidity, resistance to erosion and solar deterioration. In the embodiment of FIG. 1, planter 20 is a vacuumed formed generally rectangular receptacle having four sidewalls 22 extending upwardly from a base 24. Partitions 26 also extend upwardly from base 22 to divide planter 20 into four zones 28. In one embodiment, planter 20 measures 3′-8″×3′-8″ around a top portion thereof, 3′-2.5″×3′-2.5″ around a bottom portion thereof, and each zone 28 measures 1′-6″×1′-6″. It is contemplated that any number of partitions 26 may be utilized to divide planter 20 into any desired number of zones 28. It is also contemplated that planter 20 need not necessarily be of a generally rectangular shape. As shown in FIG. 5, planter 20 may be of a trapezoidal shape. In certain embodiments, the multiple planters 20 may be arranged to form various shapes such as a circle. Those of ordinary skill in the art will appreciate that planter 20 may be made of any desired shape. Further, it is contemplated that similarly shaped planters 20 may be stacked upon one another for efficient storage when not in use.

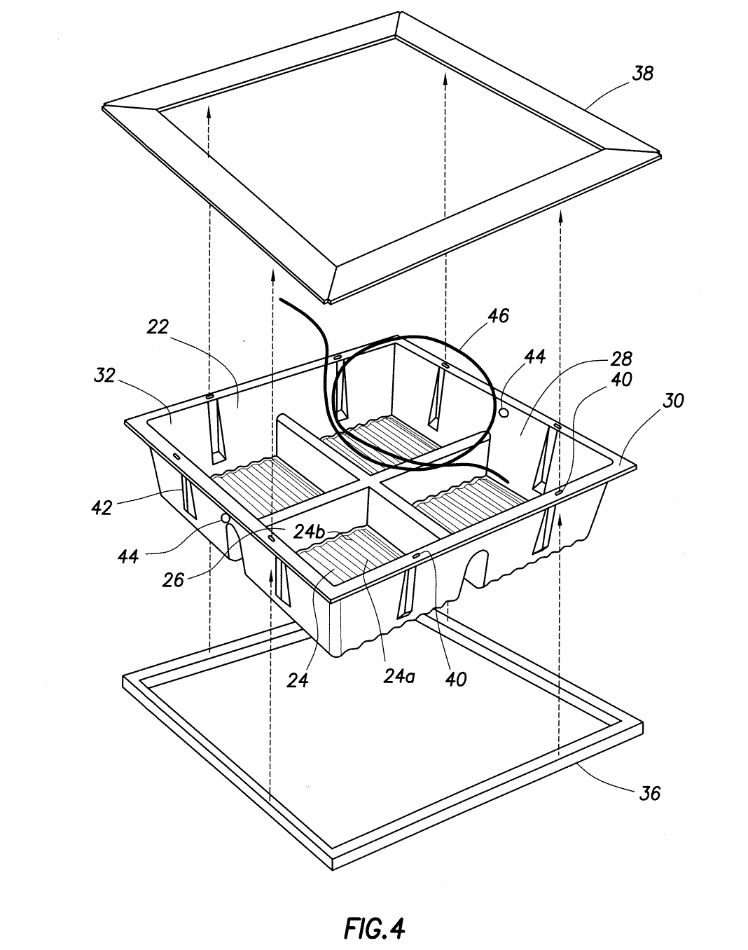

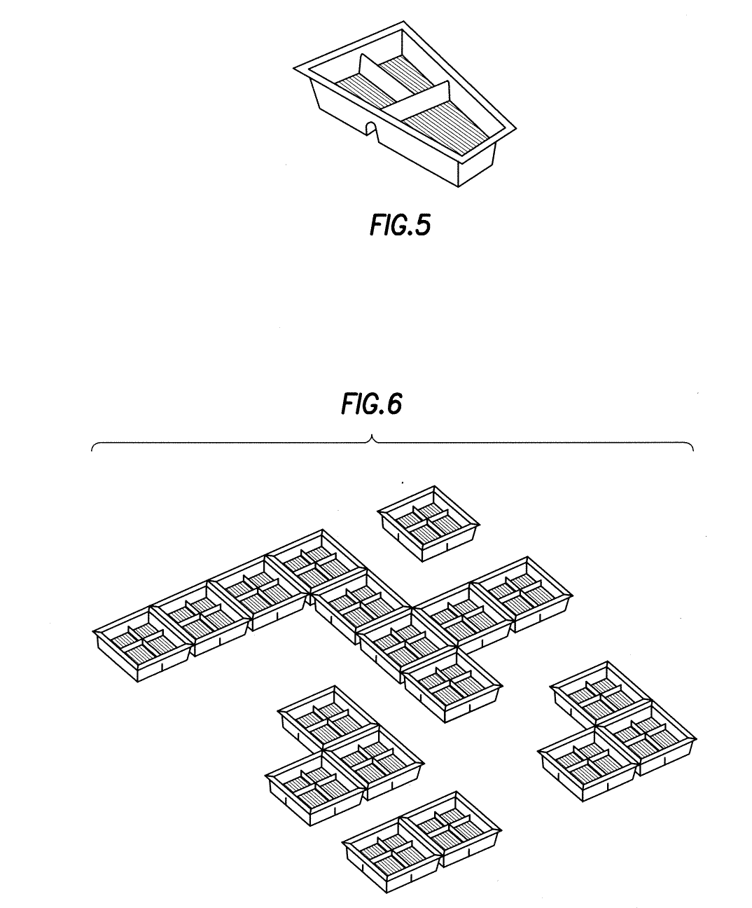

Ledge 30 extends around a top portion 32 of sidewalls 22. Ledge 30 disposed at an angle relative to sidewalls 22 such that a standard 2′×2′ or 2′×4′ frame 36 can fit thereunder as shown in FIG. 4. It is contemplated that frames of other sizes of frames may be utilized with the planter 20 of the present disclosure. In another embodiment, ledge 30 is adapted to receive a 2′×12′ member thereunder as a continuous vertical edge frame. The 2′×12′ member is desirable in situations where a plurality of planters 20 are disposed in a row to form part of a garden. Further, a 1′×6′ top board 38 is adapted to be disposed on the ledge 30 and retained thereon by screws (not shown) that are screwed through apertures 40 provided through ledge 30.

Wedges 42 are also formed on sidewalls 22 to provide re-enforcement to sidewalls 22. Further, wedges 42 can be adapted to rest on one or more anchor stakes (not shown) to prevent planters 20 from being displaced from a preferred location.

Irrigation holes 44 are provided on at least two opposing sidewalls 22 and are adapted to receive soak hose 46 that is adapted to deliver water to each of zone 26 of planter 20. In certain embodiments, soak hose 46 is disposed about 1 inch below the surface of the planting medium and may be perforated to deliver water to the planting medium. As will be understood by those of ordinary skill in the art of gardening systems, soak hose 46 may be integrated with a robust irrigation system that includes a timer and/or an interface with a weather station such that adequate amounts of water may be delivered to zones 26 without human intervention. It is contemplated that varying amounts of water may be delivered to each zone 26 depending on the water needs of each of the plants in each zone. In certain embodiments, soak hose 46 is a flexible hose that can be shaped into an “S” shape, wherein the length of sections of the “S” shaped hose can be varied such that a longer or shorter section of the “S” shaped hose is in one or more zones 26, thereby increasing or decreasing the amount of water supplied to any zone 26.

Base 24 of planter 20 is corrugated and includes alternating peaks and valleys 24a, 24b. In certain embodiments, drain holes (not shown) may be cut out from the base 24 without compromising the strength of planter 20, thereby ensuring proper drainage for the planting medium and promoting plant health and/or yield. A user can choose to cut out the drains from the peaks 24a provided on base 24. Those of ordinary skill in the art will recognize that the strength and rigidity achieved by planter 20 due to the corrugated base 24 is of particular advantage where a user desires to move planter 20 that is filled with growing medium and/or plants from one location to another without emptying the contents of planter 20 before such move.

One or more planters 20 may be placed adjacent one another to form any desired pattern or shape of planter system. It is contemplated that soak hoses 46 of adjacent planters may be disposed in fluid communication with one another to provide proper irrigation for each planter 20 in a planter system.

Therefore, the present disclosure is well adapted to attain the ends and advantages mentioned as well as those that are inherent therein. The particular embodiments disclosed above are illustrative only, as the present disclosure may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered or modified and all such variations are considered within the scope and spirit of the present disclosure. Also, the terms in the claims have their plain, ordinary meaning unless otherwise explicitly and clearly defined by the patentee.

What is claimed is:

1. A planter including;
a plurality of sidewalls extending from a base;
wherein the base is corrugated and includes alternating peaks and valleys thereon; and
an irrigation aperture disposed on at least one of the plurality of the sidewalls, wherein the irrigation aperture is adapted to receive a soak hose.

2. The planter of claim 1, further including a ledge extending around a top portion of the plurality of sidewalls.

3. The planter of claim 1, further including a frame disposed underneath the ledge;

4. The planter of claim 1, further including a top board disposed on top of the ledge, wherein the top board is adapted to be attached to a frame disposed underneath the ledge.

5. The planter of claim 1, wherein the planter is demarcated into a plurality of zones.

6. The planter of claim 5, wherein the soak hose is adapted to deliver varying amounts of water to each of the plurality of zones.

7. The planter of claim 1, wherein a drain hole is provided through the base.

8. The planter of claim 1, further including a wedge disposed on at least one of the plurality of sidewalls.

9. A gardening system comprising:
a plurality of planters disposed adjacent one another;
wherein each planter includes:
a plurality of sidewalls extending from a base;
wherein the base is corrugated and includes alternating peaks and valleys thereon; and
an irrigation aperture disposed on at least one of the plurality of the sidewalls, wherein the irrigation aperture is adapted to receive a soak hose.
